(19) United States
(12) Patent Application Publication
(10) Pub. No.: US 2011/0134633 A1
(43) Pub. Date: Jun. 9, 2011

(54) Cold cathode fluorescent lamp, and lamp device having the same

(75) Inventor: Yu-Chen Lin, Kaohsiung County (TW)

(73) Assignee: Great Top Technology Co., Ltd.

(21) Appl. No.: 12/963,197

(22) Filed: Dec. 8, 2010

(30) Foreign Application Priority Data
Dec. 9, 2009 (TW) 098223039

(51) Int. Cl. H01J 61/30; F21V 21/00

(52) U.S. Cl. 362/217.1; 313/493

(57) ABSTRACT

A lamp device includes: a lamp unit mounted in a lamp housing; and a circuit unit disposed in the lamp housing for activating the lamp unit to emit light when receiving an external voltage through opposite connecting ports mounted on the lamp housing. The lamp unit includes two cold cathode fluorescent lamps (CCFLs) connected in series. Each CCFL includes a lamp tube that has a first tube segment connected to a first electrode portion and extending in a first direction, a second tube segment connected to a second electrode portion and extending in a second direction transverse to the first direction, and a curved third tube segment interconnecting the first and second tube segments. For each CCFL, a ratio of a length of the lamp tube in the second direction to a length of the same in the first direction is less than 25%.

### CROSS-REFERENCE TO RELATED APPLICATION

This application claims priority of Taiwanese Application No. 098223039, filed on Dec. 9, 2009.

### BACKGROUND OF THE INVENTION

1. Field of the Invention

The invention relates to a lamp, and more particularly to a cold cathode fluorescent lamp, and a lamp device having the same.

2. Description of the Related Art

FIG. 1 illustrates a conventional lamp device 9 that is designed for a relatively long specification length, such as 240 cm. The conventional lamp device 9 includes: a transparent lamp housing 91 extending in a longitudinal direction; opposite connecting ports 92 mounted respectively on opposite ends of the lamp housing 91 in the longitudinal direction; two lamp units 93 mounted in the lamp housing 91; and two circuit units 94 each disposed in the lamp housing 91 and connected electrically to a corresponding lamp unit 93 and the connecting ports 92 for activating the lamp unit 93 to emit light when receiving an external voltage through the connecting ports 92. Each lamp unit 93 includes two parallel cold cathode fluorescent lamps (CCFLs) 95 connected electrically in series through a conductive connecting member 96. For each lamp unit 93, each CCFL 95 has a first electrode portion 952 coupled to a corresponding lamp socket 941 of the corresponding circuit unit 94, a second electrode portion 953 opposite to the first electrode portion 952 in the longitudinal direction and connected electrically to the connecting member 96, and an elongate lamp tube 951 interconnecting the first and second electrode portions 952, 953 and extending in the longitudinal direction. The connecting members 96 of the lamp units 93 are disposed in a central portion of the lamp housing 91 and adjacent to each other.

In such a configuration, the first and second electrode portions 952, 953 of the CCFLs 95 of each lamp unit cannot emit light. However, in use, the conventional lamp device 9 appears to have a central dark area, where the second electrode portions 953 and the connecting member 96 of the lamp units are located. Therefore, the conventional lamp device 9 cannot ensure uniform illumination.

### SUMMARY OF THE INVENTION

Therefore, an object of the present invention is to provide a cold cathode fluorescent lamp, and a lamp device having the same that can generate uniform illumination.

According to one aspect of the present invention, a cold cathode fluorescent lamp comprises:

first and second electrode portions opposite to each other; and

a lamp tube interconnecting the first and second electrode portions, the lamp tube having a first tube segment connected to the first electrode portion and extending in a first direction, a second tube segment connected to the second electrode portion and extending in a second direction that is transverse to the first direction, and a curved third tube segment interconnecting the first and second tube segment.

A ratio of a length of the lamp tube in the second direction to a length of the lamp tube in the first direction is less than 25%.

According to another aspect of the present invention, a lamp device comprises:

an elongate lamp housing extending in a first direction and having opposite ends in the first direction;

opposite connecting ports mounted respectively on the ends of the lamp housing;

at least one lamp unit mounted in the lamp housing, and including two cold cathode fluorescent lamps connected in series, each of the cold cathode fluorescent lamps having opposite first and second electrode portions, and a lamp tube interconnecting the first and second electrode portions, the lamp tube of each of the cold cathode fluorescent lamps having a first tube segment connected to the first electrode portion and extending in the first direction, a second tube segment connected to the second electrode portion and extending in a second direction that is transverse to the first direction, and a curved third tube segment interconnecting the first and second tube segments, a ratio of a length of the lamp tube of each of the cold cathode fluorescent lamps in the second direction to a length of the lamp tube of a corresponding one of the cold cathode fluorescent lamps in the first direction being less than 25%; and

at least one circuit unit disposed in the lamp housing, connected electrically to the connecting ports and the lamp unit, and activating the lamp unit to emit light when receiving an external voltage through the connecting ports.

### BRIEF DESCRIPTION OF THE DRAWINGS

Other features and advantages of the present invention will become apparent in the following detailed description of the preferred embodiments with reference to the accompanying drawings, of which:

FIG. 1 is a fragmentary, partly cutaway, schematic bottom view of a conventional lamp device;

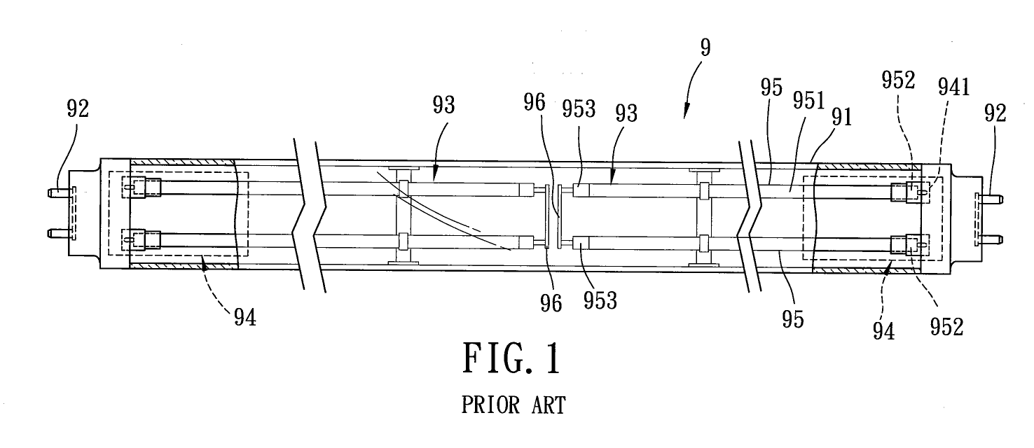

FIG. 2 is a perspective view showing the first preferred embodiment of a lamp device according to the present invention;

FIG. 3 is a fragmentary, partly cutaway, schematic bottom view showing the first preferred embodiment;

FIG. 4 is a partially schematic sectional view of the first preferred embodiment taken along line IV-IV in FIG. 2;

FIG. 5 is a fragmentary exploded perspective view showing two lamp units of the first preferred embodiment;

FIG. 6 is a schematic view of a cold cathode fluorescent lamp of the first preferred embodiment;

FIG. 7 is a fragmentary exploded perspective view showing two lamp units and a tube-mounting seat of the second preferred embodiment of a lamp device according to the present invention; and

FIG. 8 is a fragmentary, partially schematic sectional view showing an assembly of the lamp units and the tube-mounting seat of the second preferred embodiment.

### DETAILED DESCRIPTION OF THE PREFERRED EMBODIMENTS

Before the present invention is described in greater detail, it should be noted that like elements are denoted by the same reference numerals throughout the disclosure.

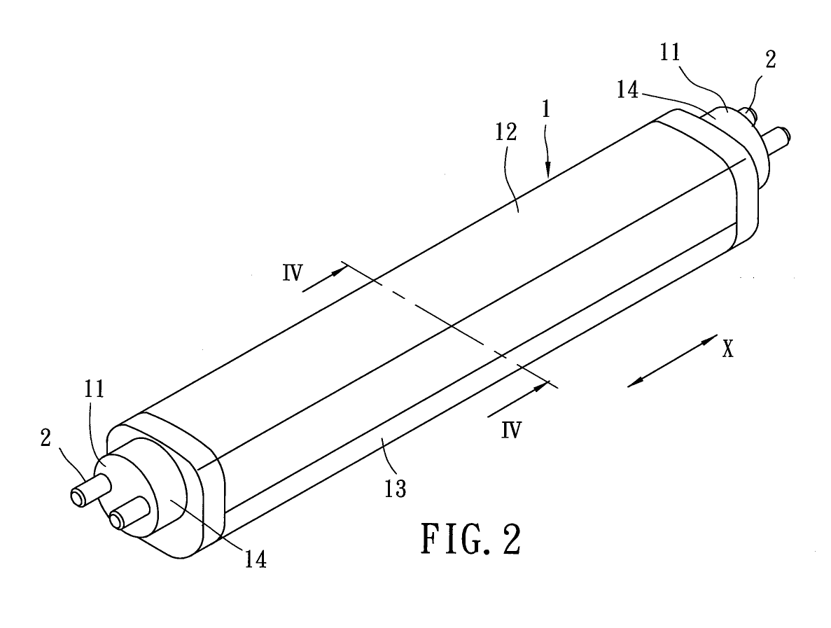

Referring to FIGS. 2 to 4, the first preferred embodiment of a lamp device according to the present invention is shown to include an elongate lamp housing 1, opposite connecting ports 2, a pair of lamp units 3, and a pair of circuit units 4.

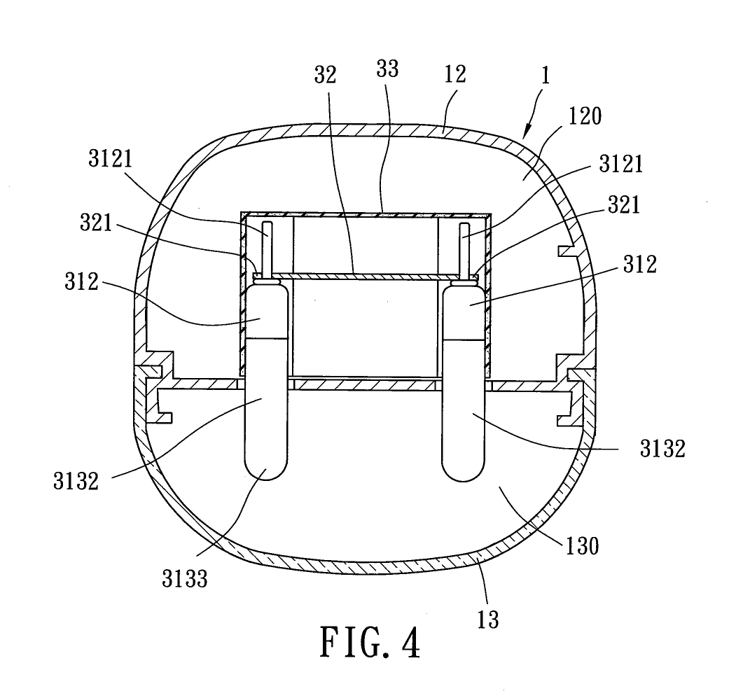

The lamp housing 1 extends in a first direction (X), and has opposite end 11 in the first direction (X). In this embodiment, as shown in FIG. 2, the lamp housing 1 includes a metallic housing part 12 extending in the first direction (X), a transparent lamp cap 13 mounted on a bottom side of the housing part 12, and opposite plastic cap bodies 14 connected to an assembly of the housing part 12 and the cap body 13. The housing part 12 is configured with a first receiving space 120 (see FIG. 4). The lamp cap 13 cooperates with the housing part 12 to define a second receiving space 130 (see FIG. 4).

Each connecting port 2 is mounted to a corresponding cap body 14 and includes two terminals extending outward of the corresponding cap body 14.

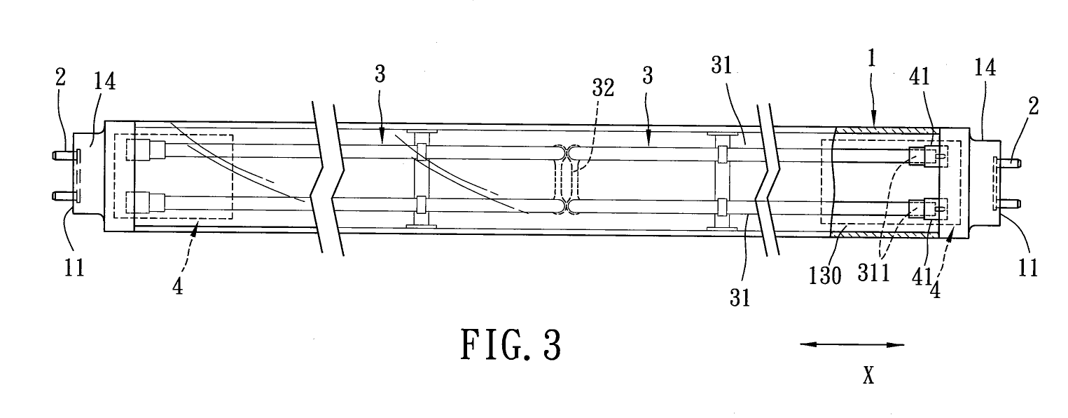

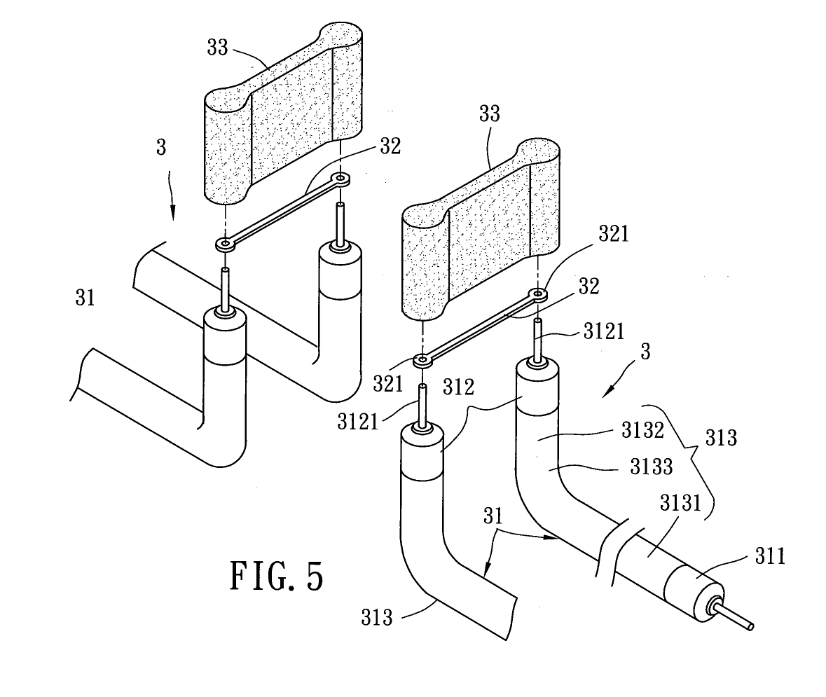

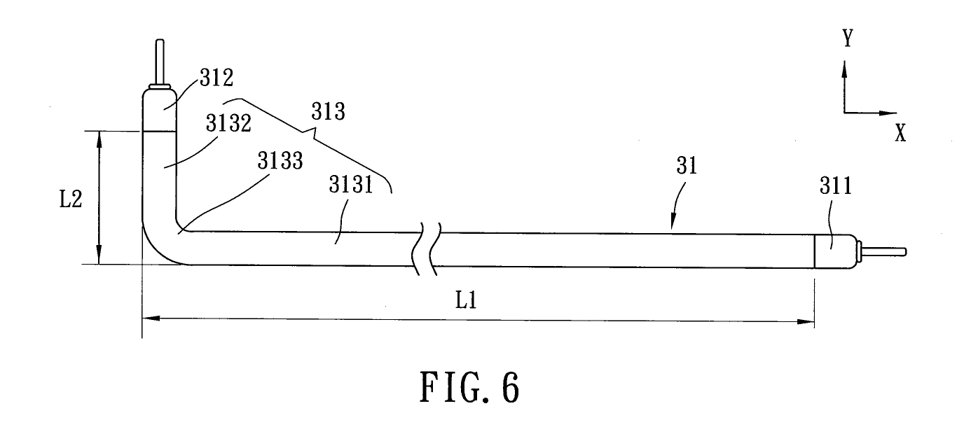

The lamp units 3 are disposed in the lamp housing 1 and are arranged spacedly in the first direction (X) (see FIG. 3). Referring further to FIGS. 5 and 6, each lamp unit 3 includes two cold cathode fluorescent lamps (CCFLs) 31, a conductive connecting member 32, and an insulating cover 33. For each lamp unit 3, each CCFL 31 has a first electrode portion 311 disposed in the second receiving space 130 (see FIG. 3), a second electrode portion 312 opposite to the first electrode portion 311 and disposed in the first receiving space 120 (see FIG. 4), and a lamp tube 313 interconnecting the first and second electrode portions 311, 312. As best shown in FIG. 6, the lamp tube 313 of each CCFL 31 has a first tube segment 3131 connected to the first electrode portion 311 and extending in the first direction (X), a second tube segment 3132 connected to the second electrode portion 312 and extending in a second direction (Y) that is perpendicular to the first direction (X) in this embodiment, and a curved third tube segment 3133 interconnecting the first and second tube segments 3131, 3132. The lamp tube 313 of each CCFL 31 of each lamp unit 3 is disposed partially within the second receiving space 130. The second tube segment 3132 of the lamp tube 313 of each CCFL 31 extends upward into the first receiving space 120 through the bottom side of the housing part 12, as shown in FIG. 4. The connecting member 32 has opposite looped end portions 321 connected electrically and respectively to lead wires 3121 of the second electrode portions 312 of the CCFLs 31 (see FIG. 4) such that the CCFLs 31 are connected in series. The insulating cover 33 is made from silicone, and is disposed in the first receiving space 120 for covering the second electrode portions 312 of the CCFLs 31 (see FIG. 4). Due to the presence of the insulating cover 33, the lamp units 3 can be disposed adjacent to each other.

Each circuit unit 4 is disposed in the lamp housing 1, and is connected electrically to the connecting ports 2 and a corresponding lamp unit 3 using electrical wires (not shown). In this embodiment, each circuit unit 4 includes two lamp sockets 41 extending into the second receiving space 130 and coupled electrically and respectively to the first electrodes portions 311 of the CCFLs 31 of the corresponding lamp unit 3, and an inverter (not shown) for activating the corresponding lamp unit 3 to emit light when receiving an external voltage through the connecting ports 2.

As shown in FIG. 6, a ratio of a length (L2) of the lamp tube 313 of each CCFL in the second direction (Y) to a length (L1) of the same in the first direction (X) is less than 25%. Preferably, the ratio ranges from 10% to 20%. For example, for the lamp device having a specification of 240 cm in length, when the ratio is 14%, the length (L1) can be 107.5 cm and the length (L2) can be 15 cm.

In such a configuration, the lamp tubes 313 of one lamp unit 3 are respectively disposed adjacent to those of the other lamp unit 3 in the first direction (X), as shown in FIG. 3. As a result, the central dark area encountered in the prior art will not occur during use. Therefore, the lamp device of the present invention can ensure uniform illumination.

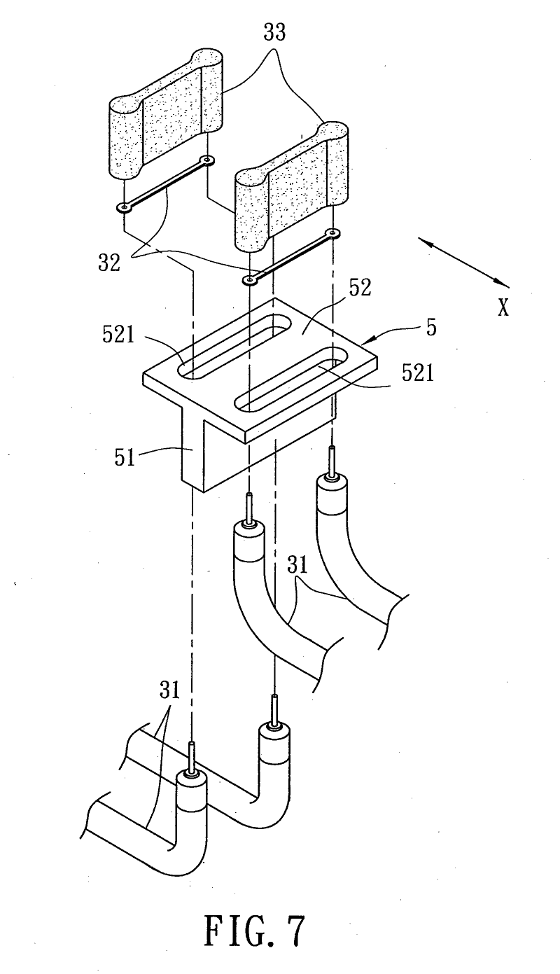

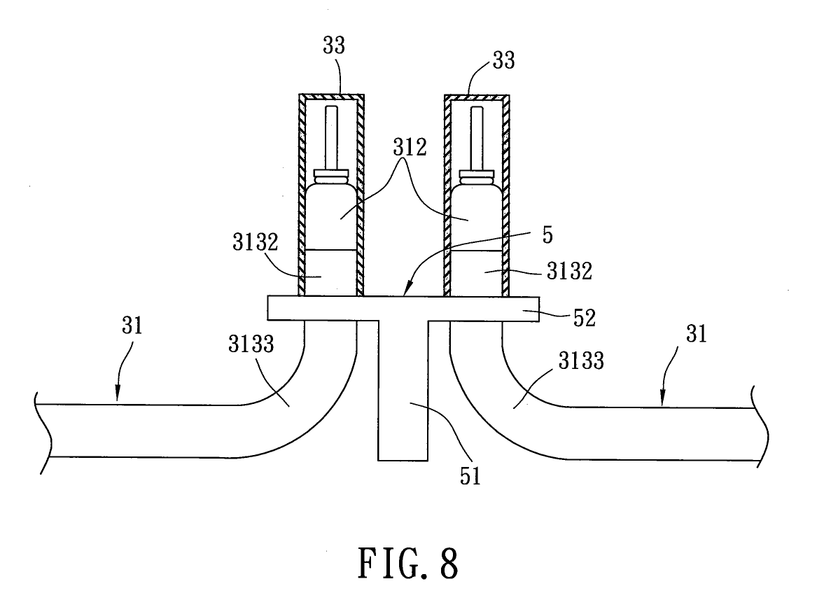

FIGS. 7 and 8 illustrate the second preferred embodiment of a lamp device according to this invention, which is a modification of the first preferred embodiment. In this embodiment, the lamp device further includes a tube-mounting seat 5 disposed in the lamp housing 1 for mounting the second tube segments 3132 of the lamp tubes 313 of the CCFLs 31 of the lamp units 3 thereon. The tube mounting seat 5 includes a main plate body 52 formed with two mounting grooves 521 opposite to each other in the first direction (X). Each mounting groove 521 permits extension of the second tube segments 3132 of the lamp tubes 313 of the CCFLs 31 of a corresponding lamp unit 3. The tube mounting seat 5 further includes a light guide element 51 extending downward from the main plate body 52 and disposed between the lamp units 3 for absorbing light emitted by the second and third tube segments 3132, 3133 of the lamp tubes 313 of the CCFLs 31 of the lamp units 3 to re-emit visible light. The light guide element 51 is made from a fluorescent material. Due to the presence of the light guide element 51, the central dark area encountered in the prior art can be avoided. Therefore, the lamp device of the present invention can ensure uniform illumination.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A cold cathode fluorescent lamp comprising:
first and second electrode portions opposite to each other; and
a lamp tube interconnecting said first and second electrode portions, said lamp tube having a first tube segment connected to said first electrode portion and extending in a first direction, a second tube segment connected to said second electrode portion and extending in a second direction that is transverse to the first direction, and a curved third tube segment interconnecting said first and second tube segments;
wherein a ratio of a length of said lamp tube in the second direction to a length of said lamp tube in the first direction is less than 25%.

2. The cold cathode fluorescent lamp as claimed in claim 1, wherein the ratio ranges from 10% to 20%.

3. The cold cathode fluorescent lamp as claimed in claim 1, wherein the first direction is perpendicular to the second direction.

4. A lamp device comprising:
an elongate lamp housing extending in a first direction and having opposite ends in the first direction;
opposite connecting ports mounted respectively on said ends of said lamp housing;
at least one lamp unit mounted in said lamp housing, and including two cold cathode fluorescent lamps connected in series, each of said cold cathode fluorescent lamps having opposite first and second electrode portions, and a lamp tube interconnecting said first and second electrode portions, said lamp tube of each of said cold cathode fluorescent lamps having a first tube segment connected to said first electrode portion and extending in the first direction, a second tube segment connected to said second electrode portion and extending in a second direction that is transverse to the first direction, and a curved third tube segment interconnecting said first and second tube segments, a ratio of a length of said lamp tube of each of said cold cathode fluorescent lamps in the second direction to a length of said lamp tube of a corresponding one of said cold cathode fluorescent lamps in the first direction being less than 25%; and
at least one circuit unit disposed in said lamp housing, connected electrically to said connecting ports and said lamp unit, and activating said lamp unit to emit light when receiving an external voltage through said connecting ports.

5. The lamp device as claimed in claim 4, wherein the ratio ranges from 10% to 20%.

6. The lamp device as claimed in claim 4, wherein:
said lamp unit further includes a conductive connecting member interconnects electrically said second electrode portions of said cold cathode fluorescent lamps; and
said circuit unit includes two lamp sockets coupled electrically and respectively to said first electrode portions of said cold cathode fluorescent lamps.

7. The lamp device as claimed in claim 4, wherein said lamp device includes a pair of said lamp units that are arranged spacedly in the first direction, and a pair of said circuit units connected electrically between said connecting ports, and connected electrically and respectively to said lamp units.

8. The lamp device as claimed in claim 7, further comprising a tube-mounting seat disposed in said lamp housing for mounting said second tube segments of said lamp tubes of said cold cathode fluorescent lamps of said lamp units thereon, said tube-mounting seat including a light guide element disposed between said lamp units for absorbing light emitted by said second and third tube segments of said lamp tubes of said cold cathode fluorescent lamps of said lamp units to re-emit visible light.

9. The lamp device as claimed in claim 8, wherein said light guide element of said tube-mounting seat is made from a fluorescent material.

10. The lamp device as claimed in claim 7, wherein each of said lamp units further includes an insulating cover for covering said second electrode portions of said cold cathode fluorescent lamps.
